(19) United States
(12) Patent Application Publication
(10) Pub. No.: US 2018/0156684 A1
(43) Pub. Date: Jun. 7, 2018

(54) APPARATUS FOR INSPECTING TIRES

(71) Applicant: LEMATEC CO., LTD, Changhua County (TW)

(72) Inventor: Vic Chen, Changhua County (TW)

(21) Appl. No.: 15/370,769

(22) Filed: Dec. 6, 2016

(51) Int. Cl. G01L 17/00

(52) U.S. Cl. CPC G01L 17/00

(57) ABSTRACT

A tire-inspecting apparatus includes a shell, a valve, two tubes and a controller system. The shell includes two channels. The valve is inserted in the shell and adapted for controlling communication of the channels with each other. The first tube includes an end inserted in the first channel and another end for connection to a valve of a tire. The second tube includes an end inserted in the second channel and another end for connection to a pump. The controller system is inserted in the shell and adapted for measuring air pressure in the tire and storing values of air pressure.

### BACKGROUND OF INVENTION

### 1. Field of Invention

The present invention relates to an apparatus for inspecting tires and, more particularly, to an apparatus for inspecting air pressure in tires.

### 2. Related Prior Art

A wheel of a car includes a tire provided on a rim. Pressurized air is filled in an annular space defined by the tire and the rim. Thus, the wheel buffers impacts on the car or tire.

The air pressure of the pressurized air should be kept in a proper range. The tire would be burst by the pressurized air if the air pressure is too high. The tire would be flat and hence worn out fast if the air pressure is too low.

To measure the air pressure, a mechanic can use a mechanical pressure gauge that includes a pointer and a dial. However, reading of the air pressure from the mechanical pressure gauge is often not precise because it depends on the mechanic's angle of view.

Therefore, the present invention is intended to obviate or at least alleviate the problems encountered in prior art.

### SUMMARY OF INVENTION

It is the primary objective of the present invention to provide an electronic pressure gauge for use with a pump.

To achieve the foregoing objective, the tire-inspecting apparatus includes a shell, a valve, two tubes and a controller system. The shell includes two channels. The valve is inserted in the shell and adapted for controlling communication of the channels with each other. The first tube includes an end inserted in the first channel and another end for connection to a valve of a tire. The second tube includes an end inserted in the second channel and another end for connection to a pump. The controller system is inserted in the shell and adapted for measuring air pressure in the tire and storing values of air pressure.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of an electronic pressure gauge according to the preferred embodiment of the present invention;

FIG. 2 is a cross-sectional view of the electronic pressure gauge shown in FIG. 1;

FIG. 3 is a block diagram of a controller system of the electronic pressure gauge shown in FIG. 1; and

FIG. 4 is a flow chart of a process executed by the controller system of the electronic pressure gauge shown in FIG. 1.

### DETAILED DESCRIPTION OF PREFERRED EMBODIMENT

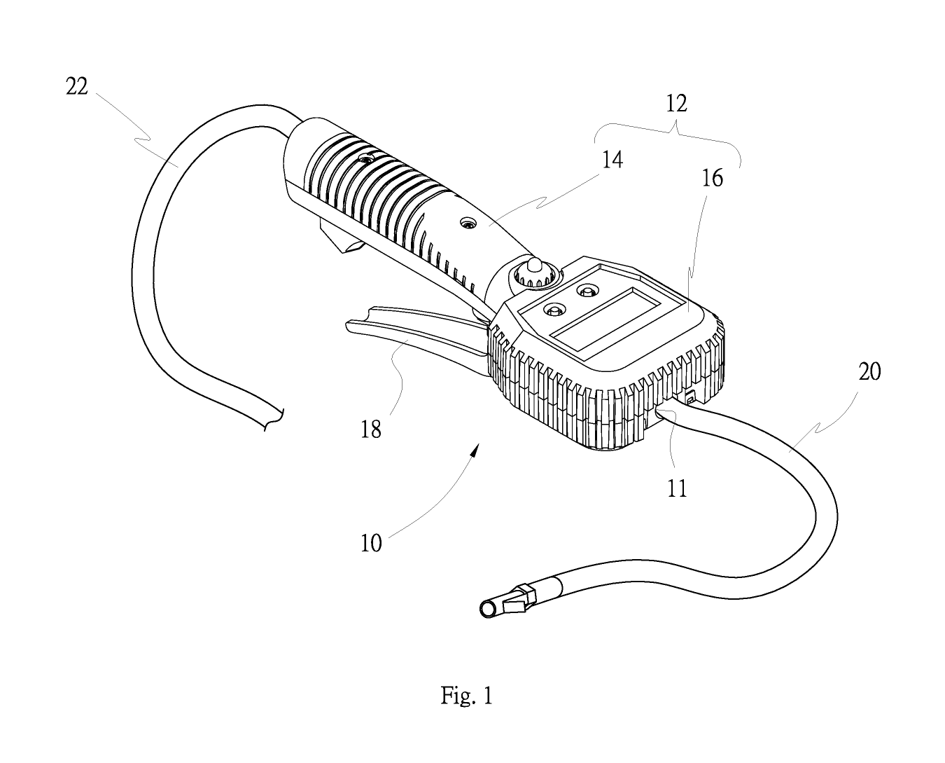

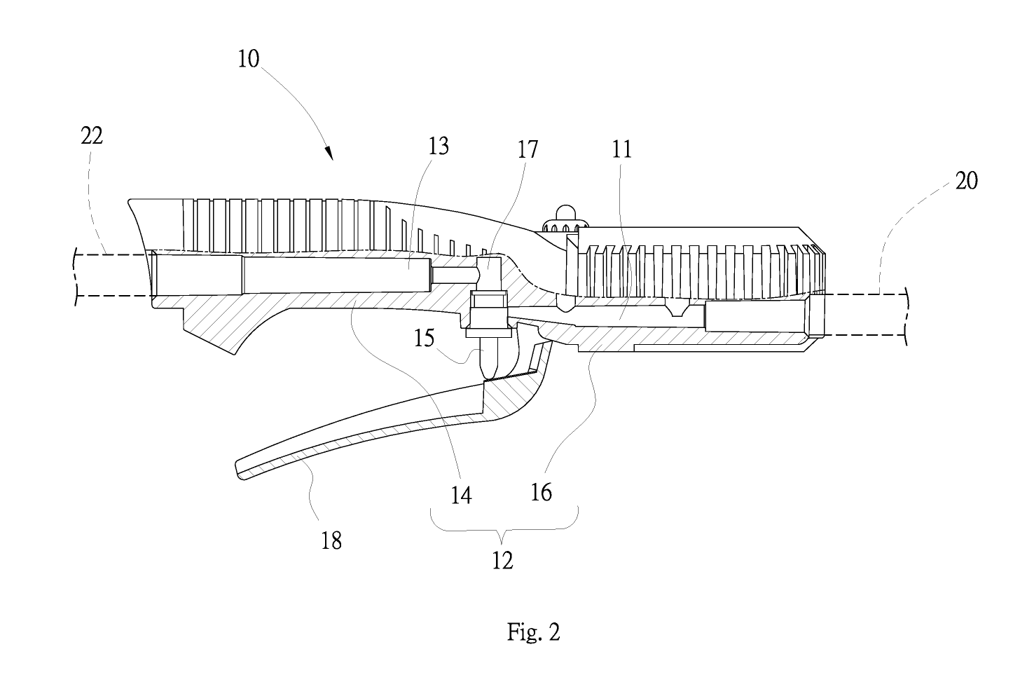

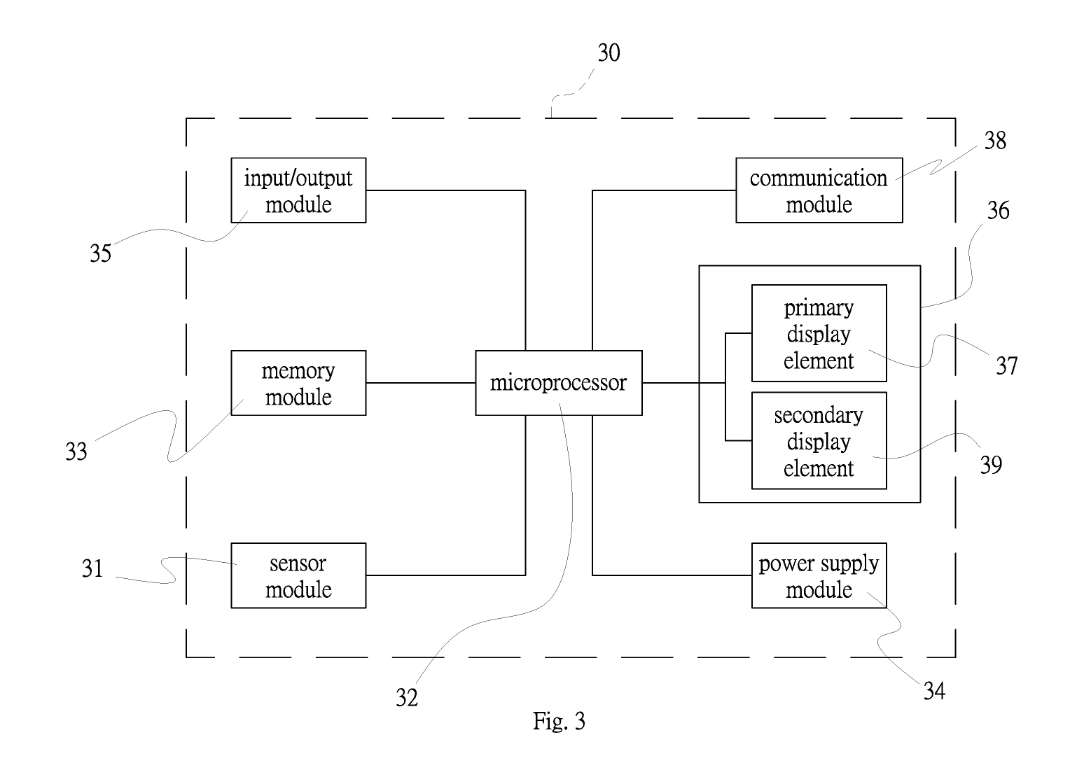

Referring to FIGS. 1 through 3, a tire-inspecting apparatus 10 includes a shell 12, two tubes 20 and 22 and a controller system 30 according to the preferred embodiment of the present invention. The tire-inspecting apparatus 10 is operable to measure air pressure in a tire.

The shell 12 includes a handle 14 connected to a body 16. A channel 11 is made in the body 16. A channel 13 is made in the handle 14. The shell 12 further includes a space 17 in communication of air with both of the channels 11 and 13. A valve 15 includes a first portion movably inserted in the space 17 and a second portion located out of the shell 12. A trigger 18 is pivotally connected to a proper portion of the shell 12 between the handle 14 and the body 16. The trigger 18 includes a portion in contact with the second portion of the valve 15. Normally, the valve 15 blocks the channel 11 from the channel 13. In operation, the trigger 18 is operable to move the vale 15 to communicate the channel 11 with the channel 13.

The tube 20 includes an end inserted in the channel 11 and another end for connection to a valve of a tire (not shown). The tube 22 includes an end inserted in the channel 13 and another end for connection to a pump (not shown).

The controller system 30 is inserted in the body 16. The controller system 30 includes a sensor module 31, a microprocessor 32, a memory module 33, a power supply module 34, an input/output module 35, a display module 36 and a communication module 38. The microprocessor 32 is electrically connected to the sensor module 31, the memory module 33, the power supply module 34, the input/output module 35, the display module 36 and the communication module 38.

The sensor module 31 includes at least one pressure sensor.

Preferably, the memory module 33 includes at least one electronically erasable programmable read-only memory element. The memory module 33 stores a predetermined value of air pressure for example and measured values of air pressure provided by the sensor module 31. The predetermined value is zero for example.

The input/output module 35 is operable to change the predetermined value.

Preferably, the display module 36 includes a primary display element 37 and a secondary display element 39. The primary display element 37 is provided on the body 16. The secondary display element 39 is provided on a portable electronic device such as a cell phone or a personal digital assisting device.

Preferably, the communication module 38 is adapted for wireless communication of signals of the secondary display element 39 with the microprocessor 32.

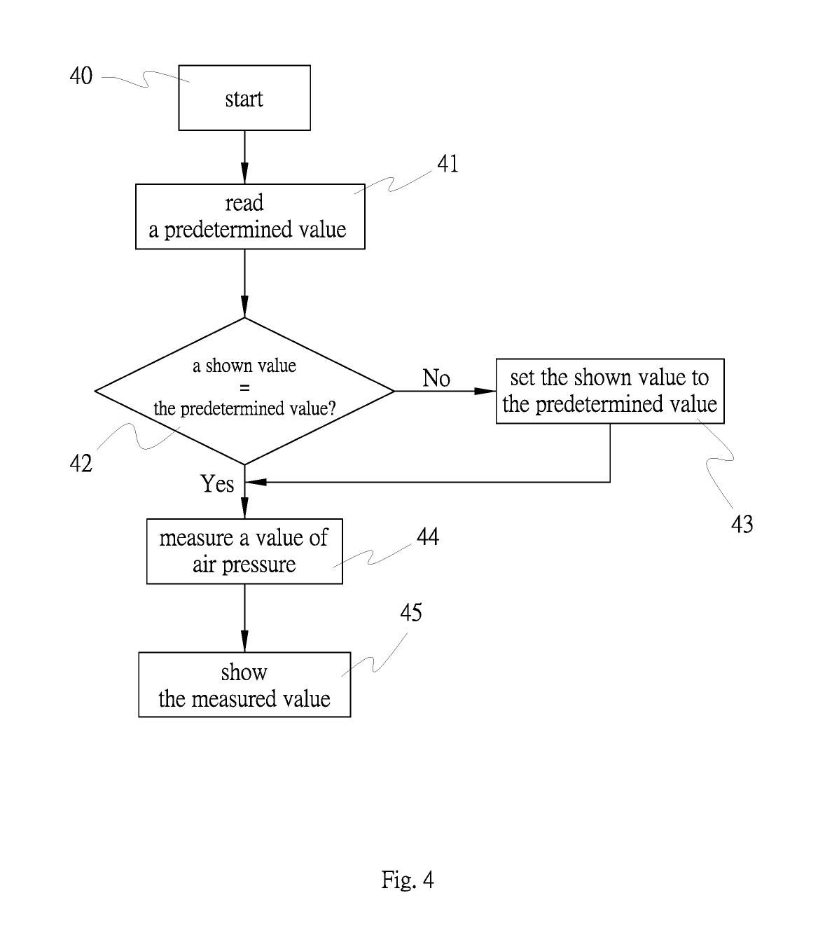

Referring to FIG. 4, the operation of the tire-inspecting apparatus will be described. In operation, at 40, the controller system 30 is turned on. That is, the power supply module 34 starts to provide power to the other modules.

At 41, the microprocessor 32 reads the predetermined value from the memory module 33.

At 42, the microprocessor 32 determines whether a value shown on the display module 36 is identical to the predetermined value. That is, the microprocessor 32 determines whether the value shown on the display module 36 is zero or not.

At 43, the microprocessor 32 sets the value shown on the display module 36 to the predetermined value if it is not identical to the predetermined value. Alternatively, the microprocessor 32 turns to 44 if the value shown on the display module 36 is identical to the predetermined value.

At 44, the sensor module 31 measures the air pressure in a tire after the tube 20 is connected to the tire. Then, the sensor module 31 sends a signal to the microprocessor 32 according to the air pressure.

At 45, the microprocessor 32 instructs the display module to show the measured value of air pressure. The measured value of air pressure is shown on both of the primary display element 37 and the secondary display element 39.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A tire-inspecting apparatus comprising:
a shell comprising a first channel and a second channel;
a valve inserted in the shell and adapted for controlling communication of the first channel with the second channel;
a first tube comprising an end inserted in the first channel and another end for connection to a valve of a tire;
a second tube comprising an end inserted in the second channel and another end for connection to a pump; and
a controller system inserted in the shell and adapted for measuring air pressure in the tire and storing values of air pressure.

2. The tire-inspecting apparatus according to claim 1, further comprising a trigger operatively connected to the valve.

3. The tire-inspecting apparatus according to claim 2, wherein the shell further comprises a handle and a body, wherein the trigger is connected to a portion of the shell between the handle and the body.

4. The tire-inspecting apparatus according to claim 3, wherein the controller system is inserted in the body.

5. The tire-inspecting apparatus according to claim 4, wherein the controller system comprises:
a sensor module for measuring values of air pressure in the tire;
a memory module for storing the measured values of air pressure;
a display module for showing the measured values of air pressure; and
a microprocessor electrically connected to the sensor module, the memory module and the display module.

6. The tire-inspecting apparatus according to claim 5, wherein the display module comprises a primary display element provided on the body and a secondary display element provided on a portable device.

7. The tire-inspecting apparatus according to claim 6, wherein the controller system further comprises a communication module for communication of signals of the secondary display element with the microprocessor.
